(19) United States
(12) Patent Application Publication
(10) Pub. No.: US 2007/0164573 A1
(43) Pub. Date: Jul. 19, 2007

(54) Trailer locking system

(76) Inventors: Cory R. Reimer, New Prague, MN (US); Brandon P. Skluzacek, New Prague, MN (US); Jason P. Skluzacek, New Prague, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 11/331,610

(22) Filed: Jan. 16, 2006

(51) Int. Cl. E05C 19/00

(52) U.S. Cl. 292/259 R

(57) ABSTRACT

A trailer locking system includes separate sections releasably coupled to provide locking frames that secure trailers against unauthorized entry through side doors and rear doors. The sections include frame members adapted for releasable coupling to other frame members to form the locking frames, along with support structure for selectively locating the locking frames relative to the trailer body. The locking frames can surround their associated trailers, or may span the width of the doors they are intended to secure. Locking frames that surround the trailers can be supported by ground engaging legs independently of the trailer, or by support members along the trailer top and sides that additionally provide a carrier for equipment and supplies. Adjacent frame members are releasably joined by coupling plates and stabilizing pins mounted to selected coupling plates. Other coupling plates have pin-receiving apertures, and all coupling plates have locking apertures to accommodate padlocks or other locking devices.

### BACKGROUND OF THE INVENTION

The present invention relates to apparatus and systems for restricting access to containers and vehicles, and more particularly, to devices for preventing unauthorized entry into unattended trailers.

Trailers serve a wide variety of personal and business needs, ranging from camping and other recreational activities, moving furniture, appliances and other personal property, to carrying tools and equipment to and from construction sites and storage at the sites. A trailer typically has a pair of hinge supported doors at its rearward end, extending substantially the full height from the deck of the trailer to its roof. The doors are securely closed by a vertically extending rod, with a lever or handle attached to the rod and pivotable into a door closing position. A latch and lock, e.g. a padlock, can be used to secure the handle in the door closing position. Some trailers include additional, single hinge supported doors along one of their side walls, with a similar vertical rod, handle and latch arrangement to secure the door.

For many uses, this locking arrangement is sufficient. However, whenever a trailer is left unattended for an appreciable amount of time, for example at a construction site or other remote location, it becomes susceptible to attempts to gain unauthorized entry, increasing the risk of theft or vandalism to the contents of the trailer.

In recognition of the need for better security, systems have been developed to augment the protection provided by the rod/handle arrangements. For example, U.S. Pat. No. 5,934,116 (Moore) shows a system with two block sections, one secured to each door of a trailer, and a rectangular bar contained in the block sections and spanning the distance between them. U.S. Pat. No. 6,834,896 (Smith) shows tubular locking assemblies designed to prevent rotation of the vertical rods away from the positions that secure the doors.

Locking devices designed to prevent entry into vehicles are shown in U.S. Pat. No. 6,349,573 (Johnson) and U.S. Pat. No. 5,035,458 (Boensch). With regard to stationary containers, U.S. Pat. No. 4,418,551 (Kochackis) and U.S. Pat. No. 5,108,166 (Klix) show cages designed to enhance vending machine security by completely surrounding the vending machines.

Although the foregoing systems may be suitable for a variety of uses, they fail to address certain objects achieved by trailer locking systems configured according to the present invention.

### SUMMARY OF THE INVENTION

The present invention has several aspects, each directed to one or more of the following objects:

The first of these objects is to provide a trailer locking system that does not require any modification of the trailer, and does not require a permanent mounting of locking system hardware to the trailer.

Another object is to provide a trailer locking system that a single individual can easily configure into a secure and positive locking engagement with the trailer.

A further object is to provide a universal locking system readily useable with a variety of trailers in a given size range.

Yet another object is to provide a trailer locking system having additional utility as a carrier.

One aspect of the invention is a locking system for securing a trailer having a substantially horizontal deck, a perimeter wall extending upwardly from the deck, a roof cooperating with the deck and perimeter wall to enclose an interior of the trailer, an entrance along the perimeter wall, a door mounted to the perimeter wall for closing the entrance, and wheels or other means of supporting the deck above ground.

The locking system includes a plurality of substantially rigid frame members. A coupling structure is provided for releasably securing the frame members to one another to form a trailer locking frame. A support structure, mounted to the trailer locking frame, is adapted to support the locking frame in a locking position in substantially surrounding relation to a perimeter wall of a trailer in close proximity to the perimeter wall, and with a portion of the locking frame extending across an entrance of the trailer to prevent the opening of a door at the entrance to gain entry into the trailer so long as the frame members are so secured. A retaining component is mounted with respect to the trailer locking frame and extends beneath a deck of the trailer when the locking frame is in the locking position, thereby being disposed to engage the deck in response to movement of the locking frame upwardly from the locking position to prevent further upward travel of the locking frame relative to the trailer.

Several advantages arise from the fact that the locking frame in the locking position substantially surrounds, but does not necessarily contact, the perimeter wall. There is no need for a tight fit or exact alignment of the locking frame with the perimeter wall or any particular segment of the perimeter wall, such as the segment where a trailer door is located. Consequently there is no need modify or adapt the trailer to accommodate the locking frame, and no need to mount locking system hardware to the trailer. In addition, the locking frame is usable with virtually any trailer within a given size range.

The preferred support structure is a plurality of elongate support legs extending downwardly from the locking frame, more particularly from selected frame members. The preferred retaining component comprises substantially horizontal extensions fixed to bottom portions of the support legs. This allows a frame member and its associated legs and extensions to be configured as a self-standing structure. For an individual working alone, this considerably eases the task of assembling the frame members into the locking frame.

Another aspect of the invention is a trailer locking apparatus. The apparatus includes a plurality of substantially rigid frame members adapted for assembly into a trailer locking arrangement. A plurality of coupling plates are mounted integrally to free end portions of the frame members and adapted to form pairs of adjacent confronting coupling plates when the frame members are assembled into the locking arrangement. The coupling plates have respective locking apertures, and the locking apertures of each confronting coupling plate pair are alignable to receive a locking device for forming a releasable locking engagement of the coupling plate pair. A first coupling plate of each coupling plate pair supports a locking pin that extends longitudinally away from the first coupling plate and is spaced apart transversely from its associated locking aperture. A second coupling plate of the coupling plate pair includes a pin-receiving aperture spaced apart transversely from its associated locking aperture to receive the locking pin and thereby prevent any substantial rotation of the coupling plates relative to one another about longitudinal axes when the coupling plates are in said releasable locking engagement.

Thus, confronting pairs of the coupling plates cooperate to enhance security of the trailer locking apparatus through greater resistance to rotation of adjacent frame members relative to one another. This improves security, not only in free standing locking systems, but also for systems in which at least one of the frame members is permanently fixed to the trailer.

Preferably the frame members along their free end portions have longitudinal axes, and the coupling plates are mounted with their major planes perpendicular to the longitudinal axes. This positions the coupling plates for more effective resistance to frame member rotation.

Yet another aspect of the present invention is a trailer lock and carrier system for use with a trailer having a deck, a perimeter wall extending upwardly from the deck, a roof cooperating with the deck and perimeter wall to enclose an interior of the trailer, an entrance along the perimeter wall, and a door mounted to the perimeter wall for closing the entrance.

The lock and carrier system includes a plurality of substantially rigid frame members. A coupling structure is provided for releasably securing the frame members to one another to form a trailer locking frame. The system further includes a locking frame support assembly including an upright support member fixed at a lower end region thereof to a selected one of the frame members, and a top support member fixed to an upper end region of the upright support member. A mounting component is adapted to mount the locking frame support assembly integrally to a trailer with the top support member extending over a roof of the trailer and with the upright support member extending downwardly from the top support member along a perimeter wall of the trailer to locate the selected frame member in close proximity to the perimeter wall, thereby to support the locking frame in a locking position with a portion of the locking frame extending across an entrance of the trailer to prevent the opening of a door at the entrance to gain entry into the trailer, so long as the frame members are so secured.

Preferably the portion of the locking frame extending across the trailer entrance is composed of a frame member other than one of the selected frame members. Then, a user can gain access to the trailer by disconnecting a single frame member from the trailer locking frame, in lieu of disassembling the frame. Accordingly it is more convenient to lock and unlock the system. The locking frame is carried by the trailer and disposed completely above the ground. As a result, the trailer can be used to transport cargo without removing or altering the system. In a particularly preferred embodiment, the locking frame support assembly comprises a forward subassembly and a rearward subassembly, each with a top support member extending substantially horizontally over the roof, and first and second upright support members extending downwardly along the perimeter wall from opposite end regions of the top support member. In this arrangement, the top support members cooperate to provide a roof top carrier for equipment and supplies, for example ladders, pipe sections and lumber.

Thus in accordance with the present invention, trailer locking systems provide enhanced security against unauthorized entry, are more convenient to use, and can be adapted to different styles of trailers within a given size range without the need to mount hardware to or otherwise modify the trailer itself. In addition, as exemplified in alternative embodiments, locking systems with components permanently attached to trailers can provide rooftop carriers.

### IN THE DRAWINGS

Further features and advantages will become apparent upon consideration of the following detailed description and drawings, in which:

FIG. 1 is a perspective view of a trailer and a trailer locking system configured according to the present invention;

FIG. 2 is a side elevation of the trailer and locking system;

FIGS. 3-5 are perspective views showing individual sections of the locking system;

FIG. 6 is a partially sectioned side view illustrating a coupling of the locking system components;

FIG. 7 is a perspective view showing a trailer and an alternative embodiment trailer locking system;

FIG. 8 is a sectional elevation illustrating the mounting of a locking system component to the trailer;

FIG. 9 is a perspective view showing the rear portion of a trailer equipped with another alternative embodiment trailer locking system;

FIG. 10 is a perspective view showing part of the side wall of a trailer equipped with a further alternative embodiment locking system;

FIG. 11 is a perspective view showing an alternative embodiment coupling plate for joining locking system components; and

FIG. 12 is an elevational view showing a hinged coupling of locking system components.

### DETAILED DESCRIPTION OF THE PREFERRED EMBODIMENTS

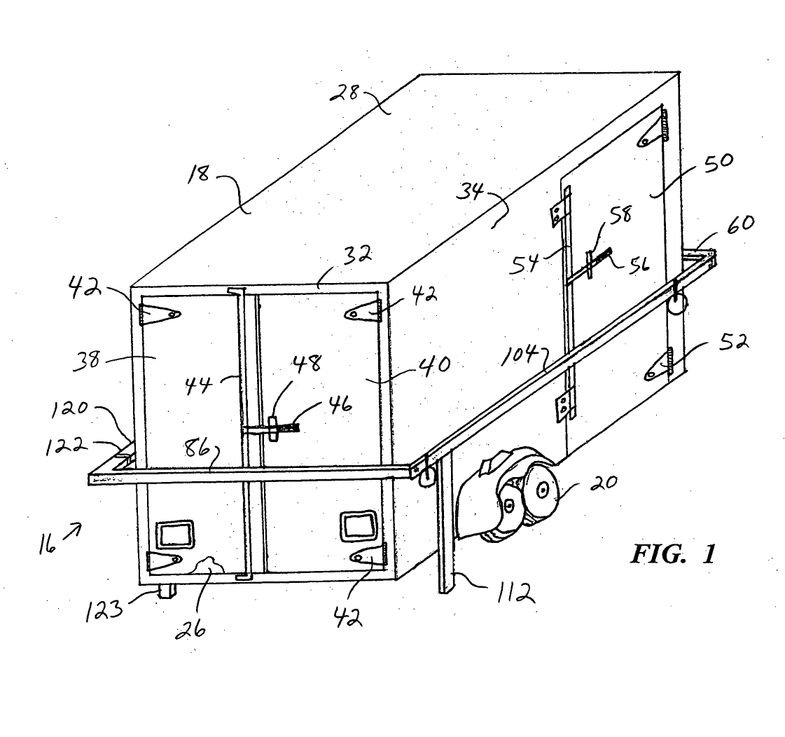

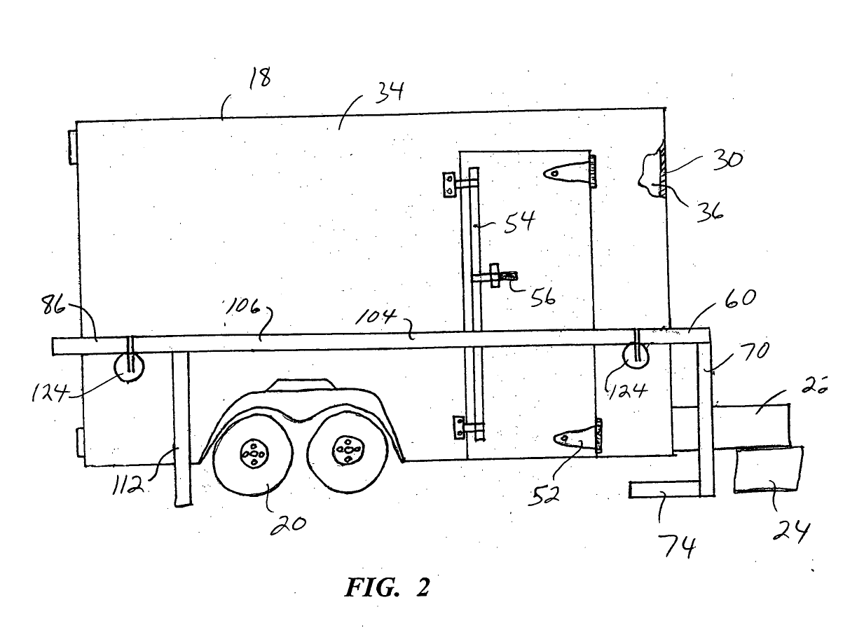

Turning now to the drawings, there is shown in FIGS. 1 and 2 a trailer locking system 16 surrounding and locking a trailer 18. The trailer has a rectangular trailer body supported above ground by wheels 20 and a hitch 22, which in use is coupled to a ball or other connector at the rear of a towing vehicle. When not in transit, hitch 22 can be supported above ground by a block 24 as shown in FIG. 2. The trailer body includes a floor or deck 26 that is horizontal when the trailer is supported as shown, a horizontal roof 28, and a perimeter wall arrangement extending vertically between the deck and roof. The perimeter wall arrangement includes a front wall 30, a back wall 32, and opposite side walls 34 and 36. A portion of side wall 34 is shown cut away in FIG. 2, to reveal front wall 30 and side wall 36.

Entrances to the trailer interior are formed through side wall 34 and back wall 32. The back entrance is closed by opposed rear doors 38 and 40, each supported pivotally by hinges 42. A portion of door 38 is shown cut away to reveal deck 26. The rear doors are kept tightly closed by a cam action rod 44, a handle 46 secured to rod 44 to pivot about an axis perpendicular to the rod length, and a latch 48 designed to capture the handle and maintain the rod in the closed position.

The side entrance is closable as shown by a side door 50 supported pivotably by hinges 52, and kept closed by a cam action rod 54, handle 56 and latch 58. While padlocks or other locking devices can be secured to latches 48 and 58 to lock the trailer, locking system 16 provides the enhanced security called for when the trailer is left unattended for extended time periods. Trailer locking system 16 is conveniently considered to include two primary functional components: a locking frame that surrounds the trailer, and a support structure for supporting the locking frame at a desired height. The locking system is composed of four sections, three of which incorporate both locking frame and support structure functions.

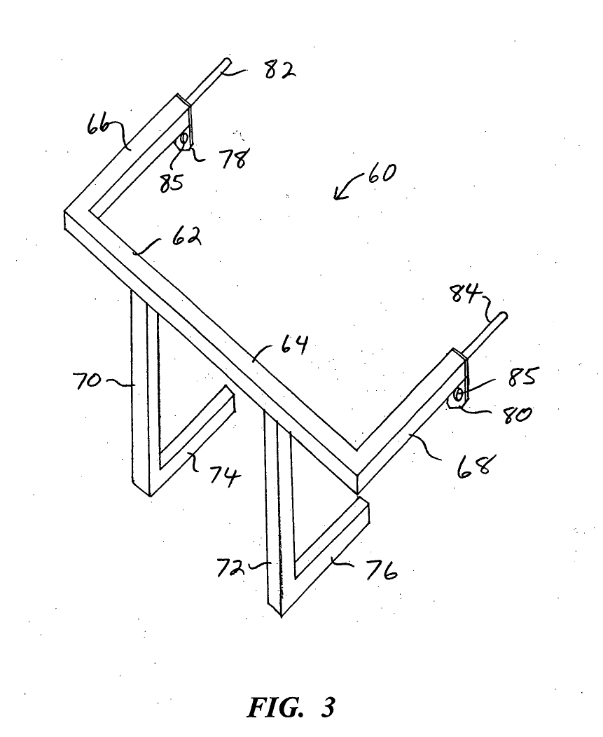

A front section 60 (FIG. 3) includes a C-shaped locking frame member 62 with a medial region 64 and opposed, parallel end regions 66 and 68. Frame member 62 is supported by a pair of vertical legs 70 and 72 with respective horizontal leg extensions 74 and 76. As seen in FIG. 2, the leg extensions are directed inwardly beneath the trailer body when locking system 16 is secured around the trailer. Thus, the leg extensions are positioned to encounter deck 26 in response to vertical travel of the locking frame relative to the trailer, to prevent further vertical travel. Due to leg extensions 74 and 76, the locking frame cannot be lifted sufficiently to remove it from the trailer.

Another useful feature of leg extensions 74 and 76 is that they are capable of supporting section 60 upright as shown in FIG. 2 when the front section is separated from the rest of locking system 16. This “stand alone” feature provides for a more convenient assembly of the system components into the locking arrangement around trailer 18, especially for an individual working alone.

At the free ends of end regions 66 and 68 are coupling components, including respective coupling plates 78 and 80, and respective stabilizing pins 82 and 84. The pins are fixed to their associated plates and extend longitudinally, i.e. in the length direction of the end regions, while the coupling plates are oriented transversely to more effectively resist rotation about longitudinal axes. A locking aperture 85 is formed through each coupling plate.

As seen in FIG. 4, a back section 86 consists essentially of a C-shaped frame member 88 with a medial region 90 and opposed, parallel end regions 92 and 94. Section 86 does not include any support structure. Coupling components at the free ends of regions 92 and 94 include a coupling plate 96 and stabilizing pin 98 associated with end region 92, and a coupling plate 100 and stabilizing pin 102 associated with end region 94. The coupling plates and pins are oriented relative to their associated end sections as previously described. Locking apertures 101 are formed through coupling plates 96 and 100.

FIG. 5 shows a side section 104 including an elongate frame member 106, coupling plates 108 and 110 at the opposite ends of frame member 106, and a vertical leg 112 depending downwardly from the frame member. Leg 112 does not have a horizontal leg extension, although such extension can be formed optionally, as indicated in broken lines at 114. No stabilizing pins extend away from frame member 106. Rather, each coupling plate is provided with a pin receiving aperture as indicated at 116 for coupling plate 108. Locking apertures 118 are formed through coupling plates 108 and 110.

The system components further include another side section 120 substantially identical to side section 104, with a frame member 122 and a vertical leg 123 to support the frame member.

In all of the sections, the frame members, legs and leg extensions preferably are formed of tubular steel, with elongate linear tubing sections welded together to form the L-shaped and C-shaped members. The coupling plates likewise are formed of steel, and are welded to their associated frame members. Other suitable materials include stainless steel, steel alloys, aluminum, fiberglass, and high tempered plastics.

Returning to FIGS. 1 and 2, locking system sections 60, 86, 104 and 120 are releasably joined by locking devices such as padlocks 124 to secure the trailer. Frame members 62, 88, 106 and 122 cooperate to form a rectangular locking frame that surrounds the trailer, supported at the desired height by legs 70, 72, 112 and 123. Frame member 88 prevents entry into the trailer through rear doors 38 and 40, while frame member 106 denies entry through side door 50.

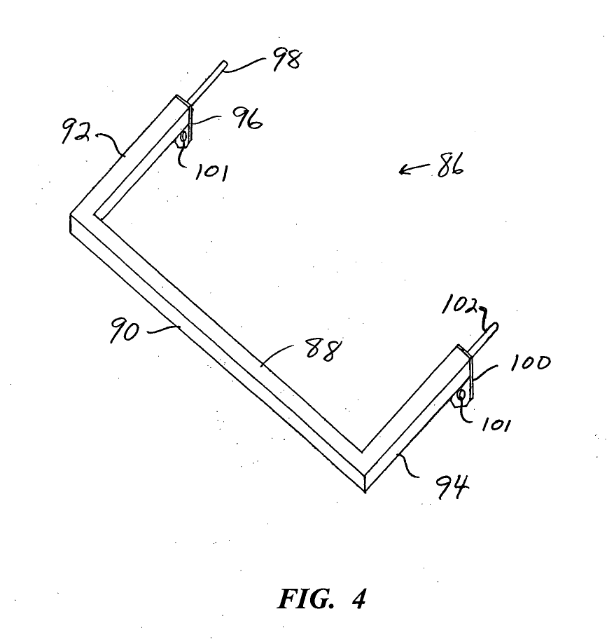

FIG. 6 illustrates the coupling of frame member 88 with frame member 106. The other system couplings are substantially identical. Just prior to coupling, end region 94 and frame member 106 are positioned to confront one another with their longitudinal axes substantially coincident, as shown. Then, as the frame members are moved longitudinally toward each other, pin 102 enters pin receiving aperture 116 to maintain the alignment during continued movement, until coupling plates 100 and 108 engage. At this point it may be necessary to rotate one of frame members 88 and 106 about the substantially coincident longitudinal axes, to bring locking apertures 101 and 118 into alignment. With the locking apertures aligned, a padlock or other suitable locking device is directed through both locking apertures. Preferably the diameter of aperture 116 exceeds the diameter of pin 102 only slightly, and the diameters of locking apertures 101 and 118 similarly only slightly exceed the captured shaft of the locking device. In that case, the locking device shaft and pin 102 cooperate to prevent any substantial rotation or transverse movement of frame members 88 and 106 relative to one another. Pin 102, acting in combination with the locking device, considerably strengthens the coupling by preventing the adjacent members from rotating relative to one another about the longitudinal axes.

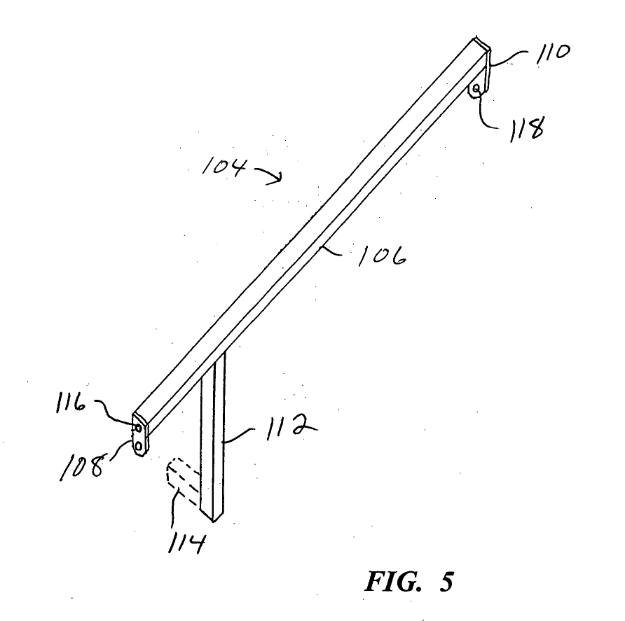

FIG. 7 illustrates an alternative embodiment trailer locking system 126 mounted to a trailer 127 similar to trailer 18. Locking system 126 includes locking frame support structure in the form of two C-shaped support members 128 and 130. Support member 128 includes a horizontal medial region 132, and vertical end regions 134 and 136 depending downwardly from opposite ends of the medial region. Similarly, support member 130 includes a medial region 138 and two vertical end regions 140 and 142.

A rectangular locking frame of system 126 is composed of a C-shaped front frame member 144, a C-shaped back frame member 146, linear side frame members 148 and 150 disposed along a side wall 152 of the trailer including a side door 154, and a side frame member 156 on the opposite side of the trailer. Adjacent frame members are releasably coupled by coupling plates and locking devices in the manner previously described.

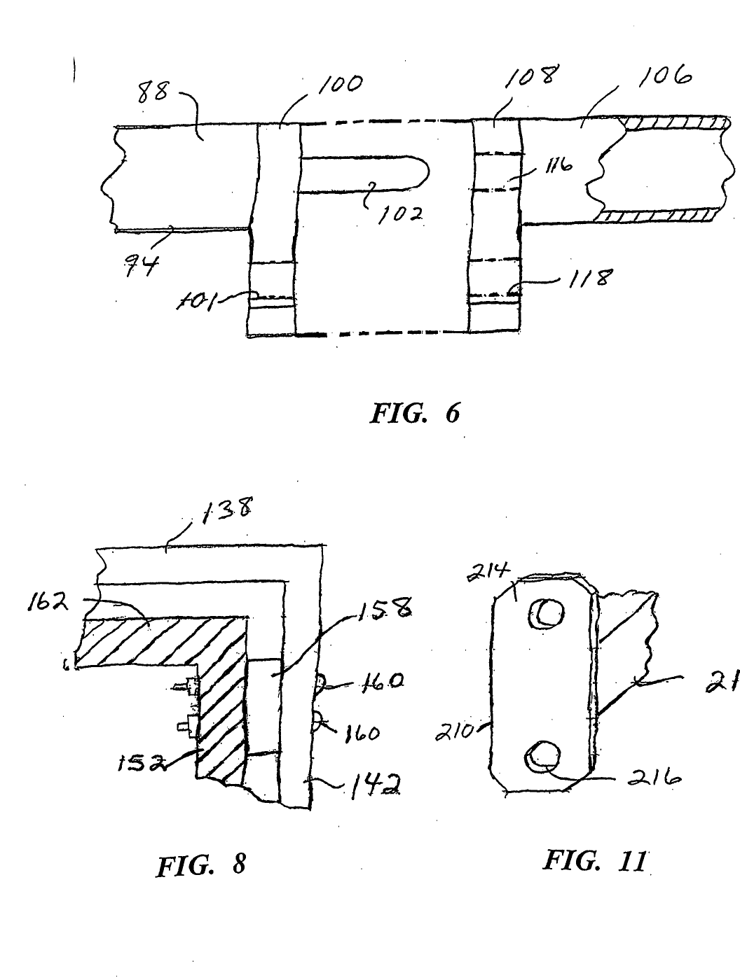

Locking system 126 is mounted permanently to trailer 127 in the sense that it is secured through mounting structure to the trailer walls using spacers and carriage bolts. FIG. 8 is a partial sectional view, taken along a vertical plane through the trailer behind support member 130. A spacer 158, preferably tubular steel, maintains end region 142 of support member 130 horizontally spaced apart from side wall 152. Carriage bolts 160 extend through the end region, spacer and side wall to secure these components while locating medial region 138 in vertically spaced apart relation to a roof 162 of the trailer.

With reference to FIG. 7, vertical end region 142 is further secured by a second spacer 164 and carriage bolts 160. Vertical end region 140 is similarly secured in spaced apart relation to the opposite side wall.

Vertical end regions 134 and 136 can be secured to the side walls in similar fashion, or alternatively can be equipped with spacers forming a frictional engagement with the trailer side walls. This latter approach allows at least limited sliding or pivoting of vertical end regions 134 and 136 to provide clearance when stabilizing pins are used to couple adjacent frame members.

Because locking system 126 is substantially permanently attached to trailer 127 rather than supported by the ground, there is no need to disassemble the system to allow the trailer to be moved to another location. The system is transported in place, along with the trailer. Further, medial regions 132 and 138 cooperate to provide a pair of rails extending across the roof of the trailer, to function as a trailer top carrier for transporting equipment and materials, e.g. ladders, pipe sections and lumber. In addition, equipment and supplies can be secured to vertical end regions 134, 136, 140 and 142 for transport with the trailer.

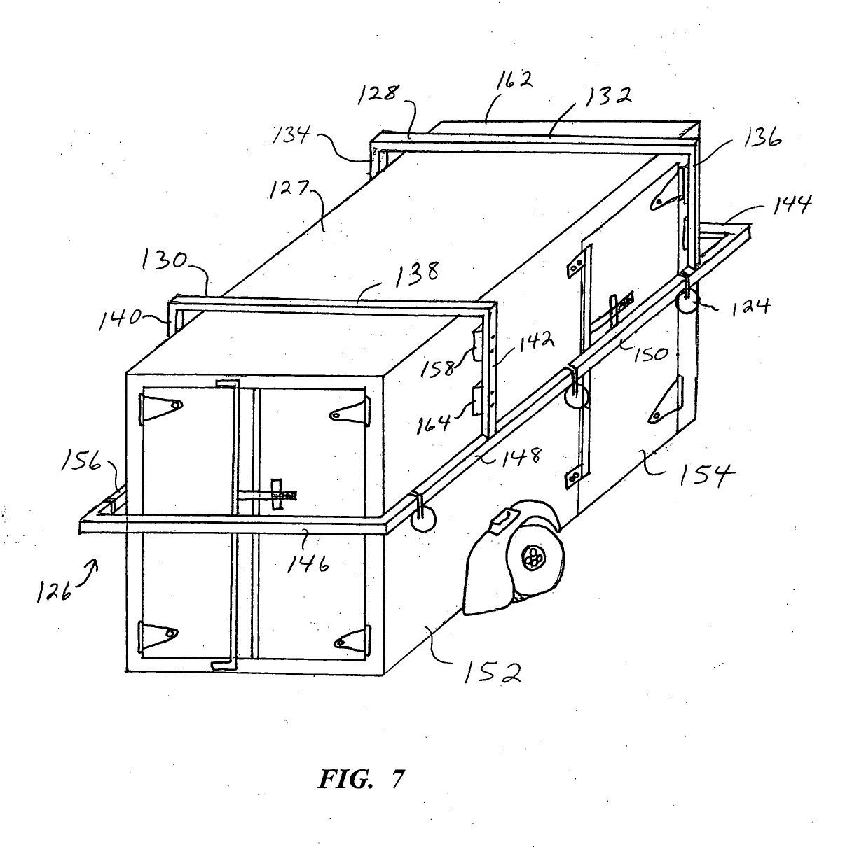

FIG. 9 illustrates the rear portion of a trailer 166 equipped with an alternative embodiment trailer locking system 168. Locking system 168 includes a linear side frame member 170 mounted to a side wall 172 of the trailer by welding the frame member to a tubular steel spacer 174 which is anchored to the side wall using carriage bolts 176. A linear side frame member 178 is mounted to the opposite side wall in similar fashion. The locking system further includes a C-shaped frame member 180 including a medial region 182 and opposed, parallel end regions 184 and 186. To secure the trailer against entry through rear doors 188 and 190, end regions 184 and 186 are releasably coupled to side frame members 170 and, 178 in the manner previously described.

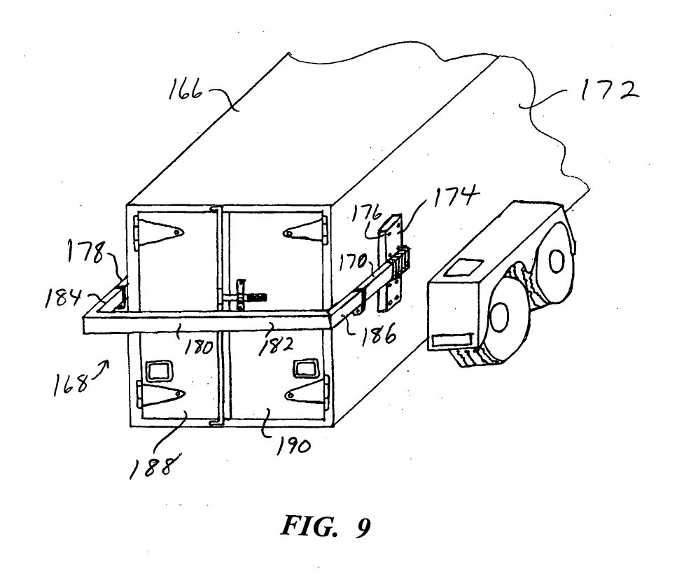

FIG. 10 illustrates a further alternative embodiment trailer locking system 192 for securing a side door 194 of a trailer 196. The locking system includes a relatively short linear frame member 198 and a similar frame member 200, mounted to a side wall 202 of the trailer with carriage bolts directed through respective mounting plates 204 and 206. A C-shaped frame member 208 includes opposite end regions attached releasably to frame members 198 and 200 in the manner previously described. The frame member secures side door 194, yet also provides clearance for hardware such as the latching bar and hinges.

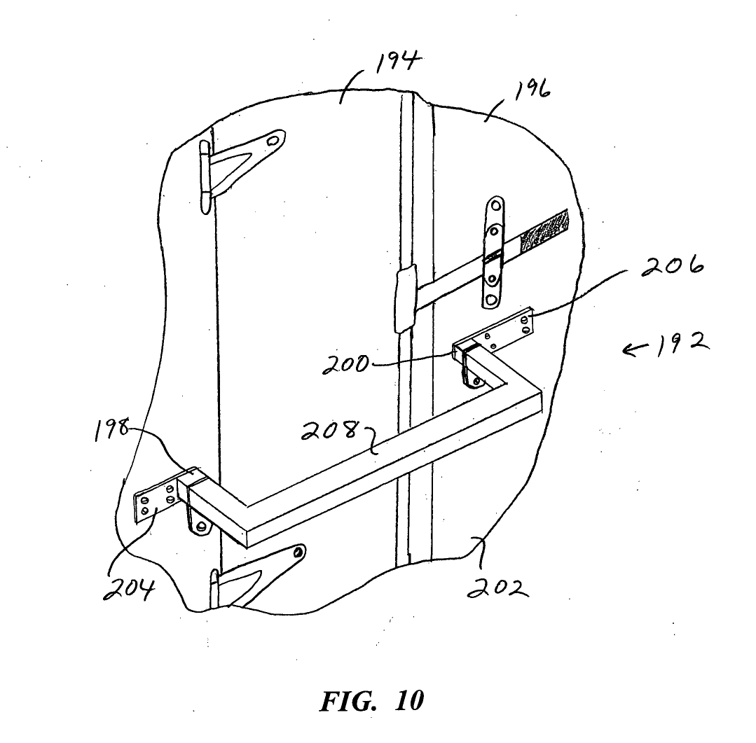

FIG. 11 illustrates an alternative embodiment coupling plate 210 attached to the end of a frame member 212. Coupling plate 210 is formed with two locking apertures 214 and 216. Frame member 212, and an adjacent frame member having a similar coupling plate, are releasably secured to one another with two locking devices. With reference to FIG. 7, an advantage of this coupling approach is that no clearance is required for stabilizing pin, for example when inserting or removing frame member 150 to prevent or allow the opening of side door 154.

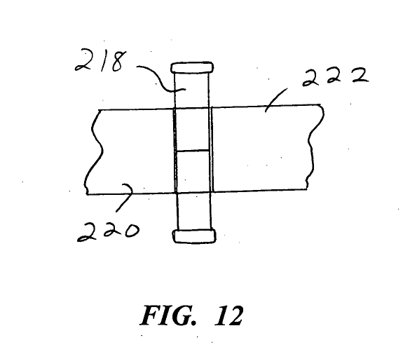

FIG. 12 illustrates a hinge 218 for coupling adjacent frame members 220 and 222. In any of the foregoing locking systems, hinged couplings can be employed in lieu of the coupling plate/stabilizing pin arrangements, to reduce the number of padlocks or other locking devices required. In locking systems 168 and 192, only one of the coupling plate/pin arrangements can be replaced with a hinge, while several hinges can be substituted into each of systems 16 and 126.

Thus in accordance with the present invention, trailer locking systems can reduce the risk of unauthorized entry, can be used to secure different trailers within a given size range, and are convenient to use. The locking systems include embodiments that require no mounting of hardware or other modifications to the trailer, and other embodiments in which the locking system also functions as a carrier.

What is claimed is:

1. A locking system for securing a trailer having a substantially horizontal deck, a perimeter wall extending upwardly from the deck, a roof cooperating with the deck and perimeter wall to enclose an interior of the trailer, an entrance along the perimeter wall, a door mounted to the perimeter wall for closing the entrance, and wheels or other means supporting the deck above ground; the locking system including:
a plurality of substantially rigid frame members;
a coupling structure for releasably securing the frame members to one another to form a trailer locking frame;
a support structure, mounted to the trailer locking frame, adapted to support the locking frame in a locking position in substantially surrounding relation to a perimeter wall of a trailer in close proximity to the perimeter wall, and with a portion of the locking frame extending across an entrance of the trailer to prevent the opening of a door at the entrance to gain entry into the trailer so long as the frame members are so secured; and
a retaining component mounted with respect to the trailer locking frame and extending beneath a deck of the trailer when the locking frame is in the locking position, thereby being disposed to engage the deck in response to movement of the locking frame upwardly from the locking position to prevent further upward travel of the locking frame relative to the trailer.

2. The system of claim 1 wherein:
the locking frame when in the locking position is substantially horizontal, and the support structure includes a plurality of elongate support legs extending downwardly from selected ones of the frame members.

3. The system of claim 2 wherein:
the locking frame is rectangular, and the frame members include a front frame member, a back frame member, and first and second side frame members; and
the support legs include first and second support legs mounted to the first and second side members respectively, and third and fourth legs mounted to the front frame member.

4. The system of claim 2 wherein:
the retaining component comprises a substantially horizontal extension fixed to a bottom portion of one of the support legs.

5. The system of claim 1 wherein:
the retaining component is mounted to the support structure.

6. The system of claim 1 wherein:
the coupling structure comprises first and second coupling plates fixed to confronting end portions of first and second ones of the frame members respectively, the coupling plates having respective first and second locking apertures positioned for alignment with one another to receive a locking device adapted to maintain the first and second plates releasably engaged.

7. The system of claim 6 further including:
a pin fixed to and extending longitudinally from the first coupling plate, wherein the second coupling plate includes an opening to receive the pin when the coupling plates are engaged.

8. The system of claim 1 wherein:
the coupling structure is adapted to releasably secure the frame members in a manner that prevents any substantial rotation of adjacent ones of frame members relative to one another.

9. The system of claim 1 wherein:
at least two of the frame members are coupled to each other by a hinge.

10. A trailer locking apparatus, including:
a plurality of substantially rigid frame members adapted for assembly into a trailer locking arrangement;
a plurality of coupling plates mounted integrally to free end portions of the frame members and adapted to form pairs of adjacent confronting coupling plates when the frame members are assembled into the locking arrangement;
wherein the coupling plates have respective locking apertures, and the locking apertures of each confronting coupling plate pair are alignable to receive a locking device for forming a releasable locking engagement of the coupling plate pair; and
wherein a first coupling plate of each coupling plate pair supports a locking pin that extends longitudinally away from the first coupling plate and is spaced apart transversely from its associated locking aperture, and a second coupling plate of the coupling plate pair includes a pin-receiving aperture spaced apart transversely from its associated locking aperture to receive the locking pin and thereby prevent any substantial rotation of the coupling plates relative to one another about longitudinal axes when the coupling plates are in said releasable locking engagement.

11. The apparatus of claim 10 wherein:
the rigid frame members when in the trailer locking arrangement cooperate to form a locking frame adapted to substantially surround a trailer in a locking position in close proximity to a perimeter wall of the trailer.

12. The apparatus of claim 11 wherein:
the locking frame is substantially horizontal when in the locking position.

13. The apparatus of claim 11 further including:
a plurality of upright support members depending downwardly from the frame members for supporting the locking frame above ground in the locking position.

14. The apparatus of claim 1 1 wherein:
at least one of the frame members is substantially permanently mounted to the trailer.

15. The apparatus of claim 10 wherein:
the rigid frame members along their free end portions have longitudinal axes, and the coupling plates are mounted with their major planes perpendicular to the longitudinal axes.

16. The apparatus of claim 10 further including:
a plurality of locking devices, one of the locking devices corresponding to each of the coupling plate pairs.

17. The apparatus of claim 16 wherein:
each of the locking devices comprises a padlock.

18. A trailer lock and carrier system for use with a trailer having a deck, a perimeter wall extending upwardly from the deck, a roof cooperating with the deck and perimeter wall to enclose an interior of the trailer, an entrance along the perimeter wall, and a door mounted to the perimeter wall for closing the entrance; the lock and carrier system including:
a plurality of substantially rigid frame members;
a coupling structure for releasably securing the frame members to one another to form a trailer locking frame;
a locking frame support assembly including an upright support member fixed at a lower end region thereof to a selected one of the frame members, and a top support member fixed to an upper end region of the upright support member;
a mounting component adapted to mount the locking frame support assembly integrally to a trailer with the top support member extending over a roof of the trailer and with the upright support member extending downwardly from the top support member along a perimeter wall of the trailer to locate the selected frame member in close proximity to the perimeter wall, thereby to support the locking frame in a locking position with a portion of the locking frame extending across an entrance of the trailer to prevent the opening of a door at the entrance to gain entry into the trailer, so long as the frame members are so secured.

19. The system of claim 18 wherein:
the mounting component is adapted to secure the upright support member with respect to the perimeter wall.

20. The system of claim 19 wherein:
the mounting component includes a spacer for maintaining the upright support member in spaced apart relation to the perimeter wall.

21. The system of claim 18 wherein:
the mounting component is configured to maintain the top support member spaced apart vertically from the roof.

22. The system of claim 18 wherein:
the locking frame in the locking position substantially surrounds the perimeter wall.

23. The system of claim 22 wherein:
the locking frame is rectangular and substantially horizontally disposed when in the locking position; and
the locking frame support assembly comprises a forward subassembly and a rearward subassembly, each of the subassemblies comprising a top support member extending substantially horizontally over the roof and first and second upright support members extending downwardly to the locking frame from opposite end regions of the top support member.

24. The system of claim 18 wherein:
the coupling structure is configured to prevent any substantial rotation of adjacent ones of the frame members relative to one another.

25. The system of claim 18 wherein:
the coupling structure comprises first and second coupling plates fixed to confronting end portions of first and second ones of the frame members respectively, the coupling plates having respective first and second locking apertures positioned for alignment with one another to receive a locking device adapted to maintain the first and second plates releasably engaged.

26. The system of claim 18 wherein:
said portion of the locking frame is composed of one of the frame members other than the selected frame member.
